(19) United States
(12) Patent Application Publication
(10) Pub. No.: US 2006/0218892 A1
(43) Pub. Date: Oct. 5, 2006

(54) Device for inclusion in systems for converting the force of gravity to electricity by using the potential and kinetic energy of weights of land vehicles, descending from higher elevations

(76) Inventor: Galen Eugene Calvert, Lonepine, MT (US)

Correspondence Address: GALEN CALVERT, 89 LONEPINE ROAD, LONEPINE, MT, 59848, US

(21) Appl. No.: 11/082,144

(22) Filed: Mar. 15, 2005

(51) Int. Cl. F02K 3/00

(52) U.S. Cl. 60/268

(57) ABSTRACT

A renewable energy capturing device is described. The three variations of this device and with aggregations thereof, make available to electric power generation components of known means, the force of gravity on weights at heights, including altitude. The devices with attachments working together, make available for conversion to electricity, large amounts of the potential energy of these various weights. This is as these weights including the weight of the vehicles, are transported downward by vehicles. This energy is otherwise wasted. These devices may be used singly or a few together but more importantly, aggregated together they capture very significant amounts of energy stored in these weights as pulled down by gravity. Gravity in itself is a renewable source of power. Described for example are two-thirds mile installations traversed at two-thirds mile a minute. Even these can produce many megawatts of electricity, but in locations amenable to much longer installations the electric power potential is only limited by the length and number of these installations.

### BACKGROUND OF THE INVENTION

The world has an ever increasing demand for electrical power, at the same time as it is running out of many of the fuels now used for its development; some of these non-renewable in the expected lifetime of mankind.

Lately, great strides have been made in extracting power from such natural sources as solar energy, and since early times, wind, wave action, the effect of wind on large water surfaces, and tides, the alternating effect of the gravitational pull of the moon and the earth on large water bodies. When the production of electric power is associated with dams, water falls and streams, this conversion of energy is called “water power”.

Used in this way “water power” is a misnomer. Water is simply the vehicle, the descent from height of which is used in converting the energy of the sun in pulling water to altitude in the first place and the force of gravity on the water in pulling the water back to its lowest possible level. It is the weight of the water and the mechanical force or energy of the vertical component of this weight's descent which is used mechanically or converted to electricity.

Therefore, other weights at altitude have similar potential for conversion to useful work and or electric power. An example from ancient time is warring parties taking the higher ground from which they could roll or throw stones and other objects on their enemies. In modern times, used much more extensively and effectively than we do, is the use by other nations of tides. In the final analysis, tidal action is composed of the mechanical force of weights at altitude of water. High tides, pulled down by the force of gravity of the earth while acted upon by the moon, become low tides.

It follows that any weight at altitude, placed there since earth's beginning, or carried up daily by the Sun or by upwardly traversing vehicles, is at that height by the expenditure of energy and thus has potential energy stored in it. Much of this energy is convertible to electrical energy by means of this invention.

For example: Just one medium sized semi-truck, having a gross vehicle weight, GVW, of 66,000 pounds, and being braked back to 40 miles per hour, MPH, while descending a 7 percent road grade involving 176 vertical feet, now wastes an estimated 352 horsepower of energy. With the 7 percent road grades now mandated, this 352 horsepower of wasted energy is derived from the estimated 5 percent grade remaining after 2 of the 7 percent grade is allowed for the freewheeling of the vehicle, without addition of fossil fuel energy.

Weather conditions and other factors permitting, the efficiency of conservation of this energy may be increased by as much as 70%. This increase in efficiency will result from increasing the current mandatory highway road grades in these areas by 50% to 10.5%. This greatly reduces the lateral travel distance and time involved. Only an estimated 2% of grade is still needed for the freewheeling of vehicles. This leaves an 8.5% grade for use in mechanical to electrical energy conversion of vehicles' weights in their descent.

For a host of reasons, efficient and effective sites for use of this invention do not exist everywhere, just as coal and oil resources do not. Like the tides from Bangladesh to France, where efficient sites do exist, the United States should use its hills and mountains to conserve this energy.

Since this is invention is of means to immediately take energy from descending vehicles, there is no closely related prior art. Hybrid vehicles and certain vehicle braking systems use the same source of energy but with the major difference of its use being kept on the vehicles.

### BRIEF SUMMARY OF THE INVENTION

As identified above, except for hybrid vehicles and certain braking systems, tremendous additional amounts of gravity energy are currently going to waste. This invention proposes an efficient and effective means to capture and use this energy for the good of mankind.

The vertical component of any vehicle's travel to altitude causes the largest fossil fuel energy expenditure of the vehicle's upward traverse. This expenditure of fossil fuel to carry weight to height greatly adds to the potential energy of the weights already there. Therefore there is a sort of double bonus anywhere vehicles, particularly trucks; traverse upward empty and come back down, loaded.

The devices may also find use in capturing the gravitational energy from the downgrade movement of trucks and other vehicles in mining, earth moving, logging and other like operations. Where there is gold and other precious metals and ores at altitude, much of the potential energy of their weight can be extracted for other useful purposes while bringing the basic material down for their intrinsic value.

One of the claims of this invention is of an aggregate of the devices arranged to descend an appropriate grade in a continuous spiral in a cylinder or as if in a cylinder wherein the exit is essentially vertical to the entrance. Used in such as a mining operation the descent may involve several thousand vertical feet. For technical reasons, but not to be limiting, the appropriate grade of such an installation is estimated to be 10.5 percent.

Enclosed as a vertical tunnel, this will do much to solve weather-related problems. The problem caused by the erratic actuation of the devices is solvable by the gravitational forces captured being used to immediately pump water from the aquafer at that height, stored, and then run in a continuous flow to standard hydro-electric generators.

Unlike the electrical energy projects relying on wave and tidal action, this invention has not nearly so severe environmental problems, nor distance to utilization of the energy. Very importantly, for already developed roadways, the production devices will be largely contained in the spaces already dedicated for road, city street and railroad right-of-ways, and/or be underground or low to the ground.

Using currently mandated maximum road grades, wherever, whenever and properly used, these devices will enable the minute by minute production of not less than estimated four (4) megawatts of electricity for each ⅔-mile installation.

Using the same speeds over the same linear distance, an increase of 70% in the usable portion of the downhill grades will result in the minute by minute production of not less than an estimated 6.80 megawatts of electricity for each ⅔ mile installation.

When used by trains and other railroad equipment on steep railroad grades, The devices, mounted on a series of stanchions, alongside railroad tracks where the grades involved are necessarily less steep, the tremendous weights of loaded trains makes the result of the same magnitude as the above.

For example, one loaded freight car weighing 240,000 pounds, descending at 40 miles per hour a grade 2% greater than that required for its freewheeling, will travel approximately 3500 feet. It will expend 3500×0.02=70×240,000=16,800,000 foot pounds of energy. This translates to 16,800,000/33,000=509.1 horsepower per car. Assuming the cars to be 70 feet long, 50 of them will travel this distance in this time. Measured in horsepower the lost energy becomes 25,454.55. This translates to 18,988 kW or the potential of 18.98 Megawatts of lost electrical energy, per minute of such traverse of trains. Between Gillette, Wyoming and Omaha, Nebr. there is something like a 3200 foot drop in altitude. Several loaded coal trains make this run daily.

Proposed to capture this energy, these devices contain and/or require conventional generators mechanically connected or powered through mechanically, pneumatically or hydraulically connected turbines. As used herein “generator/s” is meant to include generators and/or alternators.)

Though the ultimate possibilities are numerous, as above stated for railroad trains, a most practical means of immediate application of the concept is to use vehicles descending the steep road grades of the mountainous regions of the world. They will be immediately and especially useful where there is a large volume of traffic. This traffic may range from the largest double trailer and single trailer semi-trucks through other large trucks, to SUV's and the like, down to the smallest vehicles licensed for road travel, possibly excepting light, two wheeled vehicles.

All of the inventive devices are designed to accomplish the objectives of the concept while leaving that portion necessary for the vehicle to descend the grade at that point without the necessity to add power to maintain the speed of motion of the vehicle. This is estimated to be not less than the first (2) percent of grade.

By shared economic incentives and/or by law, the gross horsepower resulting from the use of these devices can be multiplied. It can easily be seen what a boon this invention can be to the citizens of countries with mountains and hills traveled by vehicles.

### DETAILED DESCRIPTION OF THE INVENTION

Device for inclusion in systems for converting the force of gravity to electricity by using the potential and kinetic energy of weights of land vehicles, descending from higher elevations.

This device is related to and derived from provisional Patent Application 60/558,689 filed Mar. 30, 2004 and 60/565/800 filed Apr. 26, 2004.

This invention is of weight accepting devices to be installed on or in existing highways and under or alongside railroad tracks. They may also become the dynamic portions of continuous earth or ore moving operations or special frontage type roadways. In all these they will convert the gravitational energy component of the descending gross weight of vehicles to linear mechanical force; this mechanical force to be converted by known means to electrical energy.

A first preferred embodiment of the invention is named the “Clamshell”. It may be of various lengths, widths and depths, depending on its projected use. It is composed of a heavy metal base structure hinged at one end, which hinge supports the moving portion.

This moving component accepts the actualizing force of the weight of the vehicle/s, moves the designed, vertical, gravitational energy portion of the device and while closing actuates the internal, mechanical, pneumatic or directly connected electrical components of the device.

These “off the shelf” components may be rotational or linear generators, accumulators, or other “off the shelf” systems. Generators, accumulators and turbines may be one to several depending on the particular installation. They may be internal to the “Clamshell” device, in the roadway, or elsewhere nearby, depending on local circumstances.

The obvious necessity of moving the upper moving portion of the device to its open, 2% grade, stasis, position is accomplished by mechanical action, residual hydraulic pressure or the actuator movement of linear actuator generators.

The vehicle's freewheeling over the remaining estimated 2% of grade is then instrumental in moving it to the following road surface and grade or to the next device. The vehicle is thus slowed without its braking.

The forces involved measured in thousands of pounds and the time of each cycle of actuation measured in seconds, including a safety factor, require that the devices themselves and their internal mechanisms be designed to continuously handle great loads. These are approximately 150,000 pounds per second for road devices and nearly 300,000 pounds for railway use.

For “fail safe” design the generators and/or accumulators need to be on the order of three to five minimum in number. This is so that in case of failure of one of them the vehicles' downhill traverse will still be sufficiently impeded.

For ease of manufacture, transportation and installation on existing twelve foot (12′) minimum lane widths, the first preferred embodiment of the invention is made in approximately 15 by 55 foot sections, 64 of which will form the basis for one of the electric power generation systems envisioned for roadways. The lengths of individual sections for railway use are approximately seventy feet. These dimensions not to be limiting.

The electrical output of each activated generator is wired in parallel or series and or altered by conventional means to most efficient and convenient current. The resulting watts may be sent through cables where by known means it is aggregated to the current from other individual units or moved directly into local use such as water pumping or to the electrical grid.

Not to be limiting, the proposed example two thirds mile units, to be traversed at approximately forty MPH, become individual electric power plants, as used individually or become part of a much larger electric power generation system as they are aggregated together. This may be for any length up to miles of the downgrade roadways or railways available.

In a first preferred embodiment of the invention the linear movement of the main movable portion of the clamshell activates a gearbox which by known means converts this linear movement to rotational movement which by a shaft spins the rotational component of the generator/s.

Another application of this first preferred embodiment of the invention envisions the immediate conversion to electricity by the use of linear generators. (This uses the linear generating device of claim 2 of Provisional Patent Application, No. 60/529,336 with filing date of Dec. 12, 2003, filed by Galen Calvert and David Diffenderfer.)

Not to be limiting, but as an instance of the invention, a typical system may span approximately 3520 linear feet of highway or railroad right of way. For highway vehicles they may use 5 of the presently mandated 7 percent maximum grades for conversion of the force involved to electricity. For railroad vehicles the grades will ordinarily be much shallower, but the actuating gross vehicle weights will be very much greater.

### BRIEF DESCRIPTION OF SEVERAL VIEWS OF THE DRAWINGS

Drawing Sheet 1 (Elevation)

FIG. 1

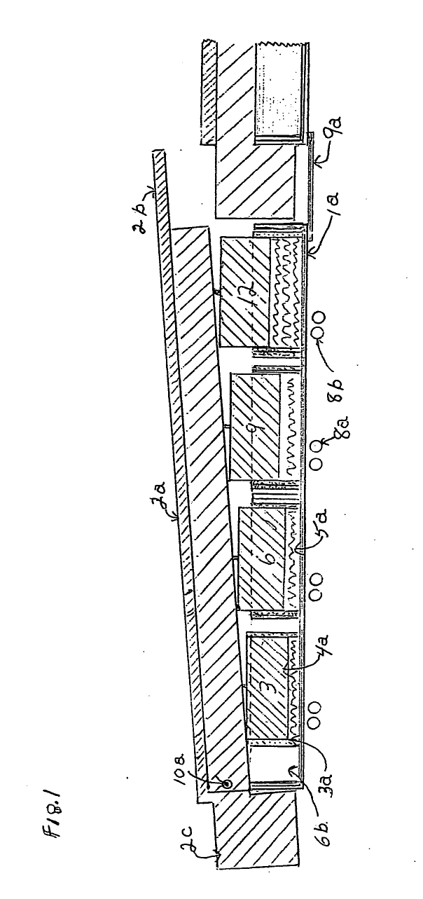

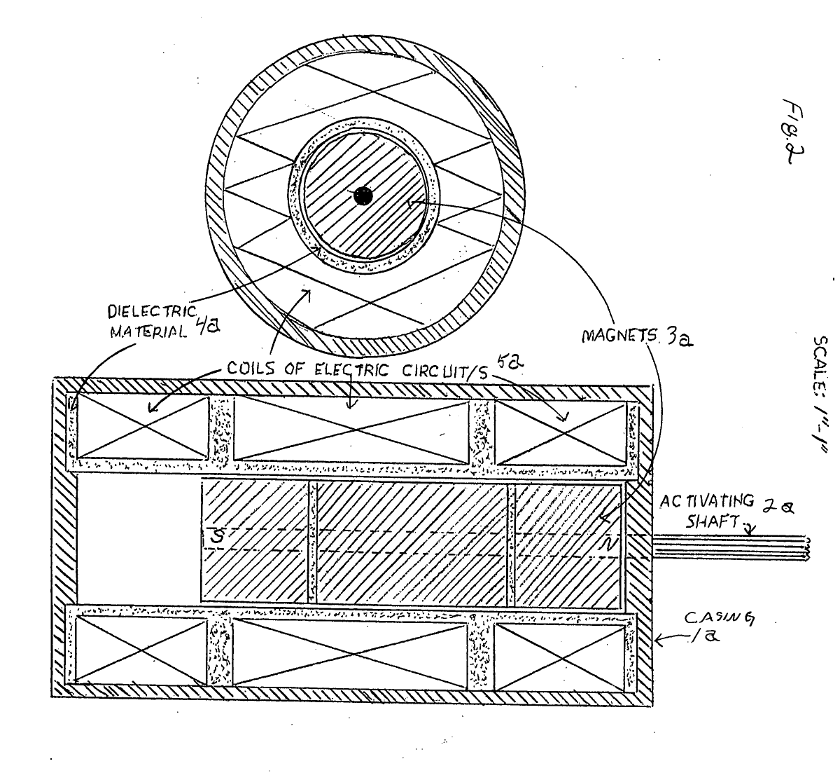

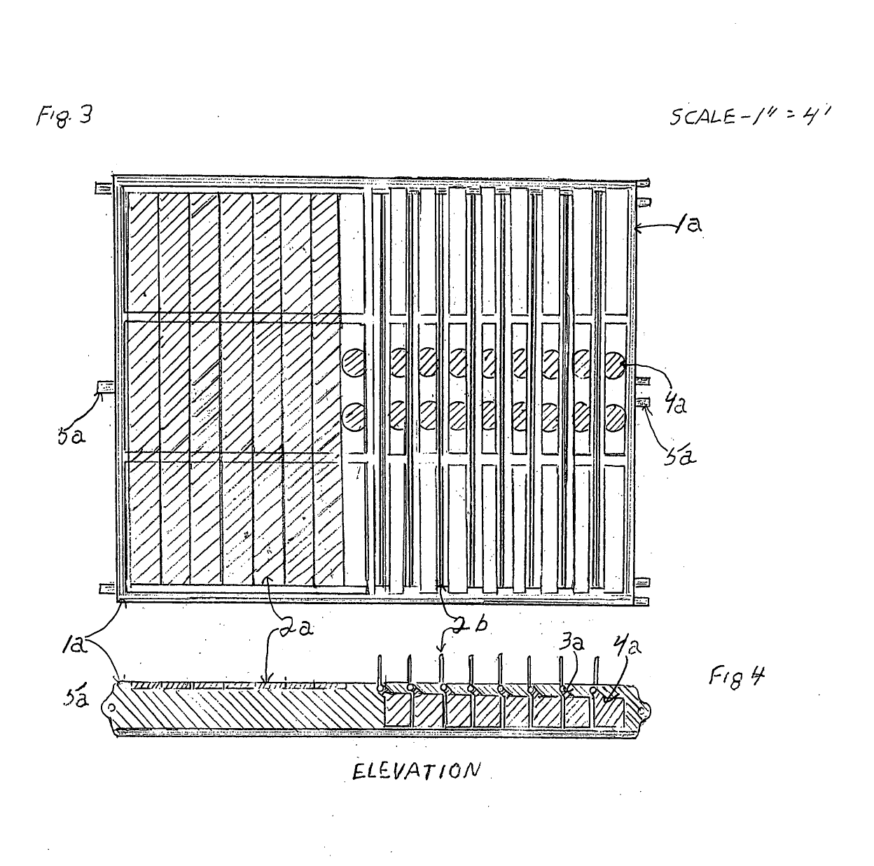

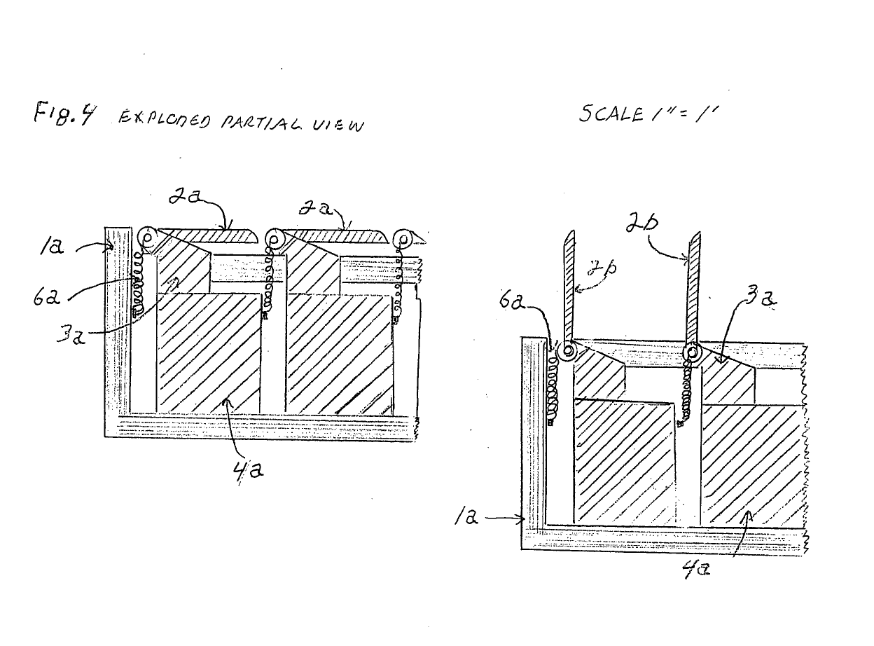

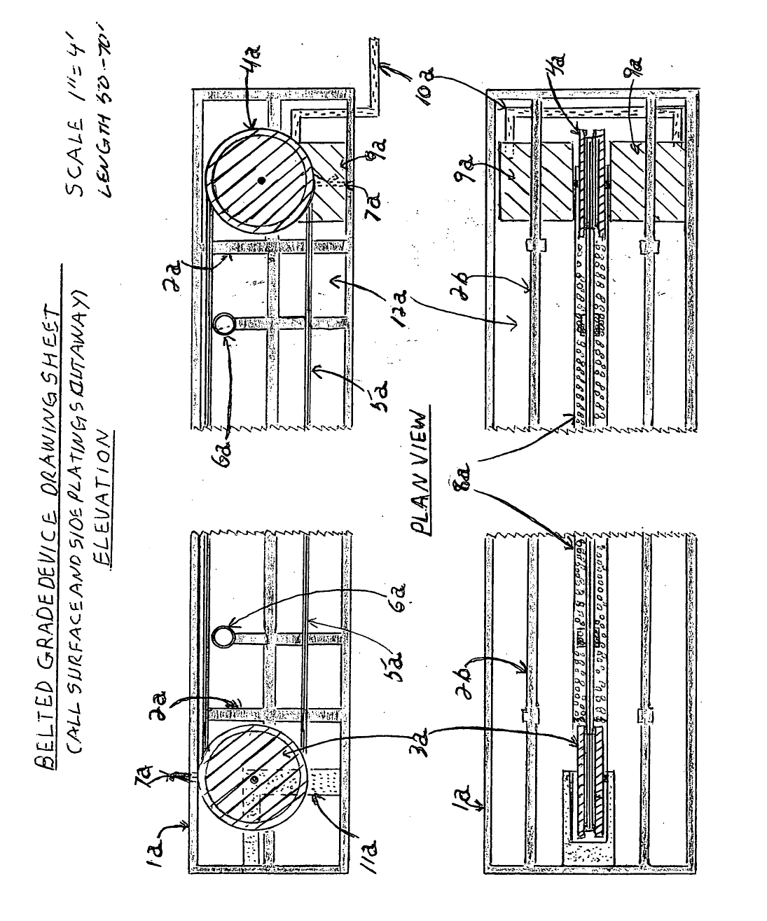

1a.—The bottom, non-moving, portion of the inventive device as set forth in claim 1.A. Front side cut away to show interior works. (Note: Level of terrain. Though shown horizontally for ease of design and viewing, this device is always in a downgrade position.)

2a.—The appropriate road or vehicle movement surface for the types of vehicles included in claims 1. and 1A.

2b.—The overhang portion of the above, necessary for the proper mating of road surfaces, railroad stanchions, etc; also necessary for surface water control.

2c.—The counter balancing portion of the above. In practice this may be larger and/or mechanized by non-inventive means.

3a.—As set forth in claim 4. of the invention, drawing shows representative Cylinder 3 of 12 pneumatic hydro/accumulators.

4a.—Like 3a above, Piston 3 of 12 pistons of pneumatic hydro/accumulator to pressurize turbines of generators.

5a.—Pneumatic area of cylinder 6. Cylinders 3, 9, and 12 also shown. Together they show the possibility of four different mechanical compression distances depending on their row's distance from the fulcrum.

6b.—Return duct part of heat exchanger unit.

8a.—Representative hydraulic piping from accumulators to turbine/s of generator/s.

8b.—Representative hydraulic piping from turbines of generators back to accumulators.

9a.—The device of claim 5, for attachment of individual units to aggregate them together.

10a.—The end of the fulcrum shaft running through the width of the device.

Drawing Sheet 2 (Plan View)

FIG. 2

1a.—Outside casing of representative linear actuator/generator.

2a.—Activating shaft from moveable components of devices.

3a.—Internal magnets

4a.—Dielectric, insulating, material.

5a.—Coils of electric circuit.

Drawing Sheet 3 (Plan View and Elevation of a representative Lattice Device.

FIGS. 3 and 4

1a.—Frame of Lattice Device.

2a.—Restraining vanes in closed position.

2b.—Restraining vanes in open position.

3a.—Gearing from vanes to representative generators or accumulators.

4a.—A representative one of many generators or accumulators.

5a.—Individual device attaching points. These may be lengthened to permit a spiraling of the aggregate assembly of devices.

Drawing Sheet 4.

FIG. 3 (Exploded partial view.)

1a.—Frame of Lattice Device.

2a.—Restraining vanes in closed position.

2b.—Restraining vanes in open position.

3a.—Gearing from vanes to generators or accumulators.

Drawing Sheet 5.

Elevation and Plan Views of Belted Grade Device. (Reverse Plan Views for rail side stanchion installation.)

1a.—Outside frame of device.

2a.—Inside vertical framing member.

2b.—Inside horizontal lateral framing member.

3a.—Powered or not First Wheel of pulley assembly.

4a.—Powered Second Wheel of pulley assembly.

5a.—Activating Belt of device.

6a.—Representative Support Wheel.

7a.—Representative one of several “Catching spines”.

8a.—Flexible active side, surface component.

9a.—Generators for direct powering or accumulators for hydro-powering of turbines of remote generators.

10a.—Hydraulic tubing to turbines of generators.

What I claim as my invention are:

1. Devices for use in systems for the conversion to electricity of the force of gravity on any vehicle descending from heights.
1.A. A device incorporating the opening and closing functions of a clam, to be known as a “Clamshell device”.
1.B. A device incorporating the opening and closing functions of certain blinds, to be known as a “Lattice Device”.
1.C. A device to be known as a “Belted-grade Device”.

2. A reciprocating action, linear generator.

3. An embodiment of the above said devices, 1A, 1B and 1C, using any number of directly driven rotational or linear actuator generators.

4. An embodiment of the above said devices 1A, 1B and 1C, using any number of accumulators to actuate generators through turbines.

5. A device for the mechanical attachment of the above said devices 1A, 1B and 1C for the purpose of use of their aggregate electrical power output.

6. An embodiment of device 5 incorporating a curvature of path, permitting a circular spiraling of devices so that the exit of the total of devices is vertically almost straight below entrance onto the aggregate of the devices.

7. Various appendages for attachment to road, railroad and off road vehicles for the purpose of “mating” with the electric power generating devices, 1A, 1B and 1C.
